(19) United States
(12) Patent Application Publication
(10) Pub. No.: US 2026/0281931 A1
(43) Pub. Date: Sep. 17, 2026

(54) METHODS AND APPARATUSES RELATING TO DETERMINING A TRANSMISSION START TIME FOR AN UPLINK SIGNAL

(71) Applicant: Nokia Technologies Oy, Espoo (FI)

(72) Inventors: Morten TOFT, Aalborg (DK); Samantha CAPORAL DEL BARRIO, Aalborg (DK); Sami-Jukka HAKOLA, Oulu (FI); Paolo BARACCA, Munich (DE); Rafael CAUDURO DIAS DE PAIVA, Cambridge (GB)

(21) Appl. No.: 19/471,476

(22) PCT Filed: Feb. 22, 2024
(86) PCT No.: PCT/EP2024/054523

§ 371 Date: Oct. 1, 2025

(30) Foreign Application Priority Data
Apr. 6, 2023 (GB) 2305118.8

(51) Int. Cl. H04W 56/00; H04L 5/00

(52) U.S. Cl. CPC H04W 56/0045; H04L 5/0091

(57) ABSTRACT

This specification describes a terminal device comprising: means for receiving first configuration information which includes an indication that a first downlink reference signal shall be used by the terminal device as a time reference for application of a timing advance value when transmitting uplink signals in accordance with a first transmission configuration indicator, TCI, state; means for receiving the first downlink reference signal; means for determining, based on a time of receipt of the first downlink reference signal and the timing advance value, a transmission start time for an uplink signal that is to be transmitted in accordance with the first TCI state; and means for transmitting the uplink signal in accordance with the transmission start time and the first TCI state.

### BACKGROUND

New Radio (NR) was first introduced in 3GPP Release 15 and the latest release is Release 18, which is still being developed. The technology described in this specification relates to improving performance of wireless telecommunications networks, particularly but not exclusively New Radio telecommunications networks.

### SUMMARY

In a first aspect, this specification describes a terminal device comprising: means for receiving first configuration information which includes an indication that a first downlink reference signal shall be used by the terminal device as a time reference for application of a timing advance value when transmitting uplink signals in accordance with a first transmission configuration indicator, TCI, state; means for receiving the first downlink reference signal; means for determining, based on a time of receipt of the first downlink reference signal and the timing advance value, a transmission start time for an uplink signal that is to be transmitted in accordance with the first TCI state; and means for transmitting the uplink signal in accordance with the transmission start time and the first TCI state.

In some examples, TCI state configuration information may comprise the first configuration information. The TCI state configuration information may include a first TCI state configuration corresponding to the first TCI state and a second TCI state configuration corresponding to a second TCI state, wherein the first TCI state configuration includes an indication that the first downlink reference signal shall be used by the terminal device as the time reference for application of the timing advance value when transmitting uplink signals in accordance with the first TCI state, and the second TCI state configuration includes an indication that the first downlink reference signal shall be used by the terminal device as the time reference for application of the timing advance value when transmitting uplink signals in accordance with the second TCI state.

In other examples, the first configuration information may indicate a plurality of TCI states for which the first downlink reference signal shall be used as the time reference for application of the timing advance value when transmitting uplink signals in accordance with any TCI state of the plurality of TCI states, wherein the plurality of TCI states includes the first TCI state and a second TCI state.

The terminal device may further comprise means for switching from transmitting uplink signals in accordance with the first TCI state to transmitting uplink signals in accordance with the second TCI state while keeping the first downlink reference signal as the time reference for application of the timing advance value when transmitting uplink signals in accordance with the second TCI state. The first downlink reference signal may be transmitted using a third beam that is wider than a first beam associated with the first TCI state and a second beam associated with the second TCI state. The third beam may spatially overlap the first beam and the second beam.

The first downlink reference signal may be a synchronisation signal block, SSB, or may be a channel state information reference signal, CSI-RS. The first configuration information may be included in a Radio Resource Control, RRC, configuration or re-configuration message or in a Medium Access Control, MAC, control element.

The terminal device may further comprise: means for receiving new configuration information for configuring transmission of uplink signals by the terminal device; means for determining that the new configuration information received at the terminal device does not include an indication that a particular downlink reference signal shall be used by the terminal device as a time reference for application of a timing advance value when transmitting uplink signals; means for, responsive to determining that the new configuration information received at the terminal device does not include an indication that a particular downlink reference signal shall be used by the terminal device as a time reference for application of a timing advance value when transmitting uplink signals, determining the time reference in accordance with an instruction stored at the terminal device.

The instruction may indicate that the time reference shall be determined based on a time of receipt of a downlink reference signal associated with one of a set of activated TCI states that is detected with a shortest path delay. The activated TCI states of the set of activated TCI states may be associated with a single transmit-receive point, TRP, or may be associated with a particular control resource set, CORESET, or may be associated with a particular CORESET pool index.

In other examples, the instruction may indicate that, when the terminal device has switched from use of an initial TCI state to use of a new TCI state, the time reference shall be determined based on a time of receipt of a downlink reference signal associated with the initial TCI state.

In other examples, the instruction may indicate that the time reference shall be determined based on a time of receipt of a reference signal that has been indicated to have a spatial relation with a physical uplink control channel, PUCCH, resource allocated to the terminal device.

In a second aspect, this specification describes a base station comprising: means for transmitting, to a terminal device, first configuration information which includes an indication that a first downlink reference signal shall be used by the terminal device as a time reference for application of a timing advance value when transmitting uplink signals in accordance with a first transmission configuration indicator, TCI, state.

In some examples, TCI state configuration information may comprise the first configuration information. The TCI state configuration information may include a first TCI state configuration corresponding to the first TCI state and a second TCI state configuration corresponding to a second TCI state, wherein the first TCI state configuration includes an indication that the first downlink reference signal shall be used by the terminal device as the time reference for application of the timing advance value when transmitting uplink signals in accordance with the first TCI state, and the second TCI state configuration includes an indication that the first downlink reference signal shall be used by the terminal device as the time reference for application of the timing advance value when transmitting uplink signals in accordance with the second TCI state.

In other examples, the first configuration information may indicate a plurality of TCI states for which the first downlink reference signal shall be used as the time reference for application of the timing advance value when transmitting uplink signals in accordance with any TCI state of the plurality of TCI states, wherein the plurality of TCI states includes the first TCI state and a second TCI state.

The first downlink reference signal may be transmitted using a third beam that is wider than a first beam associated with the first TCI state and a second beam associated with the second TCI state. The third beam may spatially overlap the first beam and the second beam.

The first downlink reference signal may be a synchronisation signal block, SSB, or may be a channel state information reference signal, CSI-RS. The first configuration information may be included in a Radio Resource Control, RRC, configuration or re-configuration message or in a Medium Access Control, MAC, control element.

In a third aspect, this specification describes a method comprising: receiving, by a terminal device, first configuration information which includes an indication that a first downlink reference signal shall be used by the terminal device as a time reference for application of a timing advance value when transmitting uplink signals in accordance with a first transmission configuration indicator, TCI, state; receiving, by the terminal device, the first downlink reference signal; determining, by the terminal device and based on a time of receipt of the first downlink reference signal and the timing advance value, a transmission start time for an uplink signal that is to be transmitted in accordance with the first TCI state; and transmitting, by the terminal device, one or more uplink signals in accordance with the transmission start time and the first TCI state.

In some examples, TCI state configuration information may comprise the first configuration information. The TCI state configuration information may include a first TCI state configuration corresponding to the first TCI state and a second TCI state configuration corresponding to a second TCI state, wherein the first TCI state configuration includes an indication that the first downlink reference signal shall be used by the terminal device as the time reference for application of the timing advance value when transmitting uplink signals in accordance with the first TCI state, and the second TCI state configuration includes an indication that the first downlink reference signal shall be used by the terminal device as the time reference for application of the timing advance value when transmitting uplink signals in accordance with the second TCI state.

In other examples, the first configuration information may indicate a plurality of TCI states for which the first downlink reference signal shall be used as the time reference for application of the timing advance value when transmitting uplink signals in accordance with any TCI state of the plurality of TCI states, wherein the plurality of TCI states includes the first TCI state and a second TCI state.

The method may further comprise switching, by the terminal device, from transmitting uplink signals in accordance with the first TCI state to transmitting uplink signals in accordance with the second TCI state while keeping the first downlink reference signal as the time reference for application of the timing advance value when transmitting uplink signals in accordance the second TCI state. The first downlink reference signal may be transmitted using a third beam that is wider than a first beam associated with the first TCI state and a second beam associated with the second TCI state. The third beam may spatially overlap the first beam and the second beam.

The first downlink reference signal may be a synchronisation signal block, SSB, or may be a channel state information reference signal, CSI-RS. The first configuration information may be included in a Radio Resource Control, RRC, configuration or re-configuration message or in a Medium Access Control, MAC, control element.

The method may further comprise receiving, by the terminal device, new configuration information for configuring transmission of uplink signals by the terminal device;

determining, by the terminal device, that the new configuration information received at the terminal device does not include an indication that a particular downlink reference signal shall be used by the terminal device as a time reference for application of a timing advance value when transmitting uplink signals; responsive to determining that the new configuration information received at the terminal device does not include an indication that a particular downlink reference signal shall be used by the terminal device as a time reference for application of a timing advance value when transmitting uplink signals, determining, by the terminal device, the time reference in accordance with an instruction stored at the terminal device.

The instruction may indicate that the time reference shall be determined based on a time of receipt of a downlink reference signal associated with one of a set of activated TCI states that is detected with a shortest path delay. The activated TCI states of the set of activated TCI states may be associated with a single transmit-receive point, TRP, or may be associated with a particular control resource set, CORESET, or may be associated with a particular CORESET pool index.

In other examples, the instruction may indicate that, when the terminal device has switched from use of an initial TCI state to use of a new TCI state, the time reference shall be determined based on a time of receipt of a downlink reference signal associated with the initial TCI state.

In other examples, the instruction may indicate that the time reference shall be determined based on a time of receipt of a reference signal that has been indicated to have a spatial relation with a physical uplink control channel, PUCCH, resource allocated to the terminal device.

In a fourth aspect, this specification describes a method comprising: transmitting, by a base station and to a terminal device, first configuration information which includes an indication that a first downlink reference signal shall be used by the terminal device as a time reference for application of a timing advance value when transmitting uplink signals in accordance with a first transmission configuration indicator, TCI, state.

In some examples, TCI state configuration information may comprise the first configuration information. The TCI state configuration information may include a first TCI state configuration corresponding to the first TCI state and a second TCI state configuration corresponding to a second TCI state, wherein the first TCI state configuration includes an indication that the first downlink reference signal shall be used by the terminal device as the time reference for application of the timing advance value when transmitting uplink signals in accordance with the first TCI state, and the second TCI state configuration includes an indication that the first downlink reference signal shall be used by the terminal device as the time reference for application of the timing advance value when transmitting uplink signals in accordance with the second TCI state.

In other examples, the first configuration information may indicate a plurality of TCI states for which the first downlink reference signal shall be used as the time reference for application of the timing advance value when transmitting uplink signals in accordance with any TCI state of the plurality of TCI states, wherein the plurality of TCI states includes the first TCI state and a second TCI state.

The first downlink reference signal may be transmitted using a third beam that is wider than a first beam associated with the first TCI state and a second beam associated with the second TCI state. The third beam may spatially overlap the first beam and the second beam.

The first downlink reference signal may be a synchronisation signal block, SSB, or may be a channel state information reference signal, CSI-RS. The first configuration information may be included in a Radio Resource Control, RRC, configuration or re-configuration message or in a Medium Access Control, MAC, control element.

In a fifth aspect, this specification describes apparatus (e.g. a terminal device or a component of a terminal device) comprising at least one processor and at least one memory storing instructions that, when executed by the at least one processor, cause the apparatus at least to perform: receiving first configuration information which includes an indication that a first downlink reference signal shall be used by the terminal device as a time reference for application of a timing advance value when transmitting uplink signals in accordance with a first transmission configuration indicator, TCI, state; receiving the first downlink reference signal; determining, based on a time of receipt of the first downlink reference signal and the timing advance value, a transmission start time for an uplink signal that is to be transmitted in accordance with the first TCI state; and transmitting one or more uplink signals in accordance with the transmission start time and the first TCI state.

In some examples, TCI state configuration information may comprise the first configuration information. The TCI state configuration information may include a first TCI state configuration corresponding to the first TCI state and a second TCI state configuration corresponding to a second TCI state, wherein the first TCI state configuration includes an indication that the first downlink reference signal shall be used by the terminal device as the time reference for application of the timing advance value when transmitting uplink signals in accordance with the first TCI state, and the second TCI state configuration includes an indication that the first downlink reference signal shall be used by the terminal device as the time reference for application of the timing advance value when transmitting uplink signals in accordance with the second TCI state.

In other examples, the first configuration information may indicate a plurality of TCI states for which the first downlink reference signal shall be used as the time reference for application of the timing advance value when transmitting uplink signals in accordance with any TCI state of the plurality of TCI states, wherein the plurality of TCI states includes the first TCI state and a second TCI state.

The instructions may, when executed by the at least one processor, cause the apparatus to switch from transmitting uplink signals in accordance with the first TCI state to transmitting uplink signals in accordance with the second TCI state while keeping the first downlink reference signal as the time reference for application of the timing advance value when transmitting uplink signals in accordance the second TCI state. The first downlink reference signal may be transmitted using a third beam that is wider than a first beam associated with the first TCI state and a second beam associated with the second TCI state. The third beam may spatially overlap the first beam and the second beam.

The first downlink reference signal may be a synchronisation signal block, SSB, or may be a channel state information reference signal, CSI-RS. The first configuration information may be included in a Radio Resource Control, RRC, configuration or re-configuration message or in a Medium Access Control, MAC, control element.

The instructions may, when executed by the at least one processor, cause the apparatus to: receive new configuration information for configuring transmission of uplink signals by the terminal device; determine that the new configuration information received at the terminal device does not include an indication that a particular downlink reference signal shall be used by the terminal device as a time reference for application of a timing advance value when transmitting uplink signals; responsive to determining that the new configuration information received at the terminal device does not include an indication that a particular downlink reference signal shall be used by the terminal device as a time reference for application of a timing advance value when transmitting uplink signals, determine the time reference in accordance with additional instructions stored at the terminal device.

The additional instructions may indicate that the time reference shall be determined based on a time of receipt of a downlink reference signal associated with one of a set of activated TCI states that is detected with a shortest path delay. The activated TCI states of the set of activated TCI states may be associated with a single transmit-receive point, TRP, or may be associated with a particular control resource set, CORESET, or may be associated with a particular CORESET pool index.

In other examples, the additional instructions may indicate that, when the terminal device has switched from use of an initial TCI state to use of a new TCI state, the time reference shall be determined based on a time of receipt of a downlink reference signal associated with the initial TCI state.

In other examples, the additional instructions may indicate that the time reference shall be determined based on a time of receipt of a reference signal that has been indicated to have a spatial relation with a physical uplink control channel, PUCCH, resource allocated to the terminal device.

In a sixth aspect, this specification describes apparatus (e.g. a base station or a component of a base station) comprising at least one processor and at least one memory storing instructions that, when executed by the at least one processor, cause the apparatus at least to transmit, to a terminal device, first configuration information which includes an indication that a first downlink reference signal shall be used by the terminal device as a time reference for application of a timing advance value when transmitting uplink signals in accordance with a first transmission configuration indicator, TCI, state.

In some examples, TCI state configuration information may comprise the first configuration information. The TCI state configuration information may include a first TCI state configuration corresponding to the first TCI state and a second TCI state configuration corresponding to a second TCI state, wherein the first TCI state configuration includes an indication that the first downlink reference signal shall be used by the terminal device as the time reference for application of the timing advance value when transmitting uplink signals in accordance with the first TCI state, and the second TCI state configuration includes an indication that the first downlink reference signal shall be used by the terminal device as the time reference for application of the timing advance value when transmitting uplink signals in accordance with the second TCI state.

In other examples, the first configuration information may indicate a plurality of TCI states for which the first downlink reference signal shall be used as the time reference for application of the timing advance value when transmitting uplink signals in accordance with any TCI state of the plurality of TCI states, wherein the plurality of TCI states includes the first TCI state and a second TCI state.

The first downlink reference signal may be transmitted using a third beam that is wider than a first beam associated with the first TCI state and a second beam associated with the second TCI state. The third beam may spatially overlap the first beam and the second beam.

The first downlink reference signal may be a synchronisation signal block, SSB, or may be a channel state information reference signal, CSI-RS. The first configuration information may be included in a Radio Resource Control, RRC, configuration or re-configuration message or in a Medium Access Control, MAC, control element.

In a seventh aspect, this specification describes a terminal device comprising: means for determining a time of receipt of a downlink reference signal associated with one of a set of activated TCI states that has a shortest path delay; means for determining, based on the determined time of receipt and a timing advance value, a transmission start time for an uplink signal that is to be transmitted in accordance with a first activated TCI state; and means for transmitting one or more uplink signals in accordance with the determined transmission start time and the first activated TCI state.

In an eighth aspect, this specification describes a terminal device comprising: means for switching from transmitting uplink signals in accordance with an initial (or pre-switch) TCI state to transmitting uplink signals in accordance with a new TCI state;

means for determining, based on a timing advance value and a time of receipt of a downlink reference signal associated with the initial TCI state, a transmission start time for an uplink signal that is to be transmitted in accordance with the new TCI state; and means for transmitting one or more uplink signals in accordance with the transmission start time and the new TCI state.

In a ninth aspect, this specification describes a terminal device comprising: means for determining a time of receipt of a reference signal that has been indicated to have a spatial relation with a physical uplink control channel, PUCCH, resource allocated to the terminal device; means for determining, based on the determined time of receipt and a timing advance value, a transmission start time for an uplink signal to be transmitted in accordance with a first activated TCI state; and means for transmitting one or more uplink signals in accordance with the transmission start time and the first activated TCI state.

In a tenth aspect, this specification describes a non-transitory computer readable medium comprising program instructions stored thereon for causing performance of any of the operations described with reference to any of the first to ninth aspects.

### BRIEF DESCRIPTION OF THE FIGURES

For better understanding of the present application, reference will now be made by way of example to the accompanying drawings in which:

FIGS. 1A and 1B illustrates a base station with multiple beams communicating with a terminal device;

FIG. 2 is an example of the UL and DL timing when a terminal device switches between two beams;

FIGS. 3A and 3B are flowcharts illustrating various operations which may be performed by the base station and terminal device in accordance with examples described herein;

FIG. 4 is a schematic illustration of an example configuration of a terminal device which may be configured to perform various operations described with reference to FIGS. 1 to 3;

FIG. 5 is a schematic illustration of an example configuration of a base station or TRP which may be configured to perform various operations described with reference to FIGS. 1 to 3; and

FIG. 6 is an illustration of a computer-readable medium upon which computer readable code may be stored.

### DETAILED DESCRIPTION

In New Radio (NR) telecommunications networks, a single base station or transmit-receive point (TRP) (which may also be referred to as a NR BS, a Node B, a gNB, a 5G node B, or an access point) can operate multiple directional beams. Such beamforming improves uplink and downlink link budgets by increasing the antenna gain. This may be particularly beneficial for the higher operating bands (e.g. in Frequency Range 2, FR2) which experience greater air-interface attenuation. Beamforming may also help to reduce inter-cell interference by focusing transmissions in a specific direction. For instance, using relatively narrow beams may reduce the potential for inter-cell interference across a wide range of angles.

Terminal devices, or user equipment (UE), connected with a TRP may switch between beams. For example, the UE may, for instance at the instruction of the network, switch from using a first beam for uplink signals to using a second beam for uplink signals. Similarly, TRPs may switch between using different beams for downlink, sometimes without the knowledge of the UE.

Some beams are associated with a respective channel state information reference signal (CSI-RS) which may be used to evaluate the beam, for instance in precoding matrix Indicator (PMI) reporting and/or beam selection refinement. Such beams may hereafter be referred to as a “CSI-RS beam”. In addition to CSI-RS beams, NR TRPs also operate wider beams that encompasses multiple CSI-RS beams. These wider beams carry the synchronisation signal block, SSB, and so may herein be referred to as SSB beams.

In order to allow UEs to configure themselves to receive downlink signals via a particular beam, and to transmit uplink signals via a particular beam, the TRP uses radio resource control, RRC, signalling to transmit Transmission Configuration Indicator (TCI) states to the UEs. These TCI states indicate, by utilising concept known as quasi co-location (QCL), which parameters the UE should use when receiving or transmitting signal. More specifically, the TCI states indicate, for respective beams that may be used by the UE, the CSI-RS beam or the SSB beam with which the respective beam is quasi co-located. The TCI states also indicate the extent of quasi co-location, i.e. the type of QCL that applies. The concept of QCL is known in the art, and so it will not be discussed in further detail herein.

In addition to indicating the relevant SSB or CSI Reference Signal, and the relevant QCL Type, the TCI states include the identity of the relevant cell and the Bandwidth Part. The TCI states may be uplink (UL) TCI states, downlink (DL) TCI states or joint uplink and downlink (UL/DL) TCI states. A UL TCI state indicates the parameters that should be used when transmitting uplink signals, a DL TCI state indicates the parameters that should be used when receiving downlink signals and a joint UL/DL state indicates that the same parameters should be used for both uplink and downlink.

RRC signalling is used to configure, at the UE, multiple TCI states (for instance, 128 for the physical downlink shared channel, PDSCH, and 64 for the physical downlink control channel, PDCCH). Although the TCI states are configured at the UE, they are by default deactivated after configuration and handover.

In the case of the PDSCH, one or more of the configured TCI states may then be activated using medium access control (MAC) control elements (CEs) that are sent to the UE. This may be done by transmitting a bitmap, where a ‘1’ indicates that the TCI State should be activated and a ‘O’ indicates that the TCI state should be deactivated. A specific activated TCI State can then be dynamically selected and signalled to the UE. This may be done using PDCCH Downlink Control Information (DCI) to indicate which of the active TCI States is applicable to a specific PDSCH resource allocation. For instance, the DCI indicates the resource allocation may also indicate which of the activated TCI States the UE should apply. The UE can then use the QCL information from the relevant TCI State to help receive and decode the PDSCH.

In the case of the PDCCH, a MAC CE may be used to activate a single one of the configured TCI States for a specific Control Resource Set (CORESET). The CORESET defines the set of Resource Blocks associated with a PDCCH Search Space. The UE can then use the QCL information from the relevant TCI State to help decode the PDCCH.

It will thus be appreciated that the network may use control signals (e.g. MAC-CEs or DCI) to cause the UE to switch between different TCI states and so to switch between use of different beams.

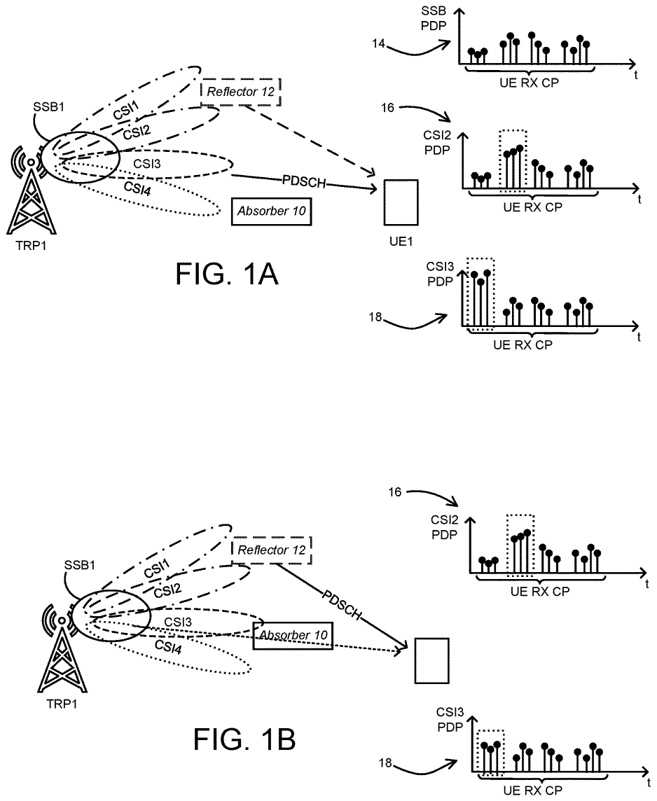

FIGS. 1A and 1B illustrate a scenario in which a terminal device UE1 switches between different beams. In the example of FIGS. 1A and 1B, the switch results from an absorber 10 in the environment having moved. However, it will also be appreciated that switches may result from another type of change in the environment, e.g. movement of a reflector, or from movement of the terminal device.

In the example of FIGS. 1A and 1B, a transmit-receive point TRP1 is operating four narrow beams CSI1 to CSI4, and one wider beam SSB1. In the example, the SSB beam SSB1 is wider than, and overlaps all, the CSI-RS beams CSI1 to CSI4. The SSB beam SSB1 also has a shorter range than the CSI-RS beams. The beams in the FIGS. 1A and 1B represent the main lobes, but it will be appreciated that each beam will have associated side lobes, which are not illustrated.

Also shown in FIG. 1A are illustrative graphs 14, 16, 18 of the power delay profiles (PDP) for the SSB beam, the CSI2-RS beam and the CSI3-RS beam. As can be seen, the PDP detected by UE1 when receiving the CSI-RS narrower beams may contain all channel taps of main lobe of the SSB beam, but the taps on the main lobes of the narrower CSI-RS beams (indicated by the dashed boxes) may be received with higher antenna gain and the other taps from the side lobes, as well the SSB main lobe, may be received with smaller antenna gain.

In FIG. 1A, the third CSI-RS beam CSI3 has the shortest path to the terminal device UE1. As such, the main lobe of the third CSI-RS beam CSI3 has the greatest power and the shortest delay (as can be seen from PDP 18 in FIG. 1A). However, it can also be seen (e.g. from PDP 16 on FIG. 1A) that, due to the presence of a reflector 12 which reflects the main lobe of the second CSI-RS beam CSI2 back towards the terminal device, the main lobe of the second CSI-RS beam CSI2 is also received with relatively high power, albeit with a longer delay than the main lobe of the third CSI-RS beam CSI3. The network may be configured to select the UL or joint UL/DL TCI state based on the CSI-RS that is received with the highest power. As such, in the example of FIG. 1A, a TCI state that is associated with (or quasi co-located with) the CSI-RS transmitted via the third beam CSI3 may be selected by the network as the UL or joint UL/DL TCI state.

In FIG. 1B, it can be seen that, at a later point in time, an absorber 10 has moved into the path of the third CSI-RS beam CSI3. As such, the third CSI-RS beam is no longer received with the highest power (see 18 of FIG. 1B). Instead, the second CSI-RS beam CSI2 is received with the highest power, even though it does not have the shortest propagation path (see PDP 16 of FIG. 1B). It will thus be appreciated that FIG. 1B is an example of a scenario in which signals transmitted using the beam having the shortest delay is not received with the strongest power. In FIG. 1B, since the second CSI-RS beam CSI2 is now received with the highest power, the network may cause to the UE to switch to a UL or joint UL/DL TCI state that is associated with (or quasi co-located with) the CSI-RS transmitted via the second beam CSI2.

As explained above, the propagation path to the terminal device is different after the TCI state switch (or post-switch) in FIG. 1B, in this case longer, than it is before the TCI state switch (or pre-switch) in FIG. 1A. In order to cause terminal devices to transmit uplink signals at the desired time, the network provides the UE with a timing advance (TA) value. This TA value is to compensate for the propagation path between the terminal device and the TRP. The TA value may be set to twice the propagation delay (although it may include adjustments). The terminal device may use this TA value along with a time of receipt of the reference signal associated with the TCI state to determine a start of transmission of an uplink signal. However, this TA value may not be updated each time a terminal device switches between UL (or joint) TCI states. For instance, where there is no new random-access preamble transmission ordered by the network, e.g. the base station, the timing advance value cannot be updated, since the TA value is provided in the random access response, RAR. As such, the terminal device UE continues to use the existing TA value until a new timing advance command (TAC) is received.

As noted above, the TA value is dependent on the propagation path delay between the TRP and the terminal device. However, since the propagation delay may be different before and after the UL (or joint) TCI state switch, the propagation delay difference between the old and new TCI states may result in the uplink signals transmitted post-switch being misaligned. Base stations may require that all UL signals transmitted by terminal devices using a particular TCI state should be received within a particular period, which may be, but is not necessarily, ⅓ of the base stations cyclic prefix (see e.g. 3GPP R1-1707951). In the case of a large propagation delay difference, the difference between the time of receipt of an uplink signal from the terminal device that has just switched to a new TCI state and the time of receipt of uplink signals from other terminal devices using that TCI state may be more than can be tolerated by the base station. That is, the uplink signal from the terminal device that has just switched may be received outside the particular period. This may result in inter-symbol interference (ISI) at the base station, which may cause uplink performance degradation. In addition, it may even cause uplink loss for all the terminal devices transmitting on the new TCI state due to loss of orthogonality among the occupied subcarriers by different terminal devices. In addition, in some cases, the base station may not even be able to estimate the uplink timing error, and as such may not be able to adjust it with a new TAC.

Implementations of the technology described in this specification may prevent or at least reduce instances of such issues which may otherwise result from TCI state switches.

In one example aspect, the network, e.g. a base station/TRP of the network, provides terminal devices with first configuration information which includes an indication of a first downlink reference signal that shall be used by the terminal device as a time reference for application of a timing advance value when transmitting uplink signals in accordance with a first TCI state. Put another way, the network explicitly indicates to the terminal device the reference signal that should be used by the terminal device for determining uplink signal timing. The terminal device then determines, based on a time of receipt of the indicated first downlink reference signal and a timing advance value (e.g. that was previously provided by the base station), a transmission start time for an uplink signal that is to be transmitted in accordance with the first TCI state. The uplink signal is then transmitted in accordance with the transmission start time and the first TCI state.

By indicating to the terminal device the reference signal that shall be used when determining timing of uplink signal transmissions using particular TCI states, it is possible to ensure that the same reference signal is used for multiple active TCI states. In this way, when the terminal device switches between two active TCI states, the same reference signal can be used for determining uplink signal timing. This may reduce the change in propagation delay of the reference signal between the base station and the terminal device that may otherwise result from the switch between TCI states and, in so doing, may reduce occurrence of the issues discussed above, including the UL inter-symbol interference at the TRP.

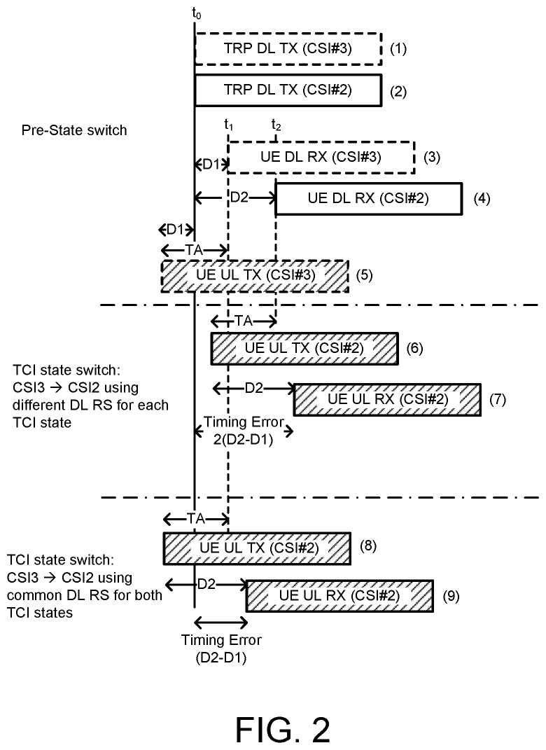

FIG. 2 illustrates the beneficial effects of utilising a common reference signal for determining uplink transmission timing for both an initial (pre-switch) TCI state and a new (post-switch) TCI state. In the example of FIG. 2, the first or initial TCI state is, similarly to FIG. 1A, associated with (or QCL with) the reference signal on CSI3, and the second or new TCI state is associated with (or QCL with) the reference signal on CSI2. The boxes with solid lines in FIG. 2 represent the signals associated with CSI 2 and the dashed lines represent signals associated with CSI3. The shaded boxes represent uplink signals, and the un-shaded boxes represent downlink signals.

Signal (1) represents the transmission time of a DL reference signal from the TRP on the CSI3 beam. Signal (2) represents the transmission time of a DL reference signal from the TRP on the CSI2 beam. In this example, signals (1) and (2) are shown to be transmitted at the same time to (or, in other words, with ideal synchronisation).

Signal (3) represents the time at which the CSI3 DL reference signal is received at the terminal device. Signal (4) represents the time at which the CSI2 DL reference signal is received at the terminal device. In this example, the CSI2 beam has a longer propagation path than the CSI3 beam, and so the CSI2 DL reference signal is received at the terminal device after the CSI3 DL reference signal. CSI3 DL reference signal is received with a path delay of D1 and the CSI2 DL reference signal is received with a path delay of D2. So, the the CSI3 DL reference signal is received at a time t₀+D1, and the CSI2 DL reference signal is received at a time t₀+D2.

Signal (5) represents the timing of transmission of an uplink UL signal from the terminal device to the TRP. Signal (5) is transmitted pre-TCI state switch and so is sent using a TCI state that is associated with CSI3. The network has provided a timing advance (TA) which is intended to ensure that the UL signal (5) is received at the TRP as close as possible to t₀. In other words, the timing advance is for ensuring that the signal is received time aligned at the TRP. In an ideal situation, such as that illustrated in FIG. 2, the timing advance is twice the path delay of the relevant reference signal. As such, in this example, the timing advance is 2×D1. The terminal device applies the timing advance-based on the time of receipt of the relevant reference signal at the terminal device, in this case t₁. So, the uplink signal sent on the TCI state associated with CSI3 is sent at a time t₁−TA(=t₀−D1).

Signals (6) and (7) represents a situation after the terminal device has switched from a TCI state associated with CSI3 to a TCI state associated with CSI2, but in which the approaches described herein are not applied. That is, after the terminal device has switched to a TCI state associated with CSI2, the terminal device uses the CSI2 DL reference signal to determine the timing of uplink transmissions.

Signal (6) represents a time of transmission of an uplink signal using the TCI state associated with CSI 2. As can be seen, the terminal device applies the TA value determined before the switch to the TCI state associated with CSI 2 (i.e. the timing advance value that was determined based on the time of receipt of the CSI3 DL reference signal) but based on the time of receipt of the CSI2 downlink reference signal (shown as t₂ in FIG. 2). So, the start of the transition time for uplink signal (6) is t₂−TA(=t₀+D2−2D1).

Signal (7) represents the time of receipt of signal (6) at the TRP. As can be seen, it is received at a time D2 after its transmission time, so at a time t₀+2D2−2D1. Thus, given that the signal would ideally be received at time to, the timing error is 2(D2−D1), where D2−D1 is the difference in path delay that results from the TCI state switch. As noted above, depending on the difference in path delay that results from the TCI state switch, the timing error may result in a number of undesirable effects, not least ISI.

Signals (8) and (9) represent a situation after the terminal device has switched from a TCI state associated with CSI3 to a TCI state associated with CSI2, but in which the approaches described herein are utilised. More specifically, the approaches described herein are utilised to ensure that the same DL reference signal is used for determining UL transmission timing before and after the TCI state switch. In this specific example, the CSI3 DL reference signal is used is used for determining UL transmission timing before and after the switch to the TCI state associated with CSI2. However, it will be appreciated that a different reference signal may be used, as long as the same reference signal is used before and after the TCI state switch. For instance, the reference signal may be transmitted via a beam that is wider than the beams associated with CSI3 and CSI2. The reference signal may, for instance, be a synchronisation signal block, SSB. By using a beam that is wider than, and overlaps with, the beams associated with the relevant TCI states, the reference signal is more likely to be received by the terminal device with sufficient strength over a wider area, and so is likely to be received by the terminal device when using any of the relevant TCI states.

Signal (8) represents a time of transmission of an uplink signal using the TCI state associated with CSI2. However, in this case, the uplink signal transmission time is determined using the time of receipt of the CSI3 downlink reference signal. So, the start of the UL transmission is t₁−TA(=t₀−D1).

Signal (9) represents the time of receipt of signal (8) at the TRP. The path delay between the terminal device and the TRP that is associated with the TCI state associated with CSI2 is D2. As such, the time of receipt of signal (8) at the TRP is t₀−D1+D2. Thus, the timing error when using the approaches described herein is D2−D1. It can therefore be appreciated that this timing error is half of the timing error that results when determining uplink transmissions timings in the manner described with reference to signals (6) and (7). In other words, when the terminal device is switching between different UL TCI states using the approaches described herein, it may be able to switch to a TCI state with a greater propagation delay difference without causing any ISI at the base station, than if the approaches described herein are not applied.

As discussed above, to enable a common DL reference signal to be used as an uplink timing reference for multiple TCI states, the terminal device may, according to some examples described herein, be provided with first configuration information which includes an indication (e.g. an identifier) of a particular downlink reference signal that shall be used by the terminal device as a time reference for application of a timing advance value when transmitting uplink signals in accordance with a particular TCI state. In some examples, the first configuration information is included in TCI state configurations. In this way, first and second TCI state configurations can each include the indication of the same downlink reference signal. Thus, when the terminal device switches between the first and second TCI states, it knows to use the same downlink reference signal for determining UL transmission timing in the second TCI state as in the first TCI state.

Examples of the first configuration information included in a TCI state configuration, as otherwise defined in 3GPP TS38.331, are shown below. The first example is for a joint UL/DL TCI state and the second example is for a UL TCI state. The first configuration information is underlined and in bold.

Example 1 - joint UL/DL TCI state configuration

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| additionalPCI-r17 | AdditionalPCIIndex-r17 | OPTIONAL, -- Need R |
|---|---|---|
| pathlossReferenceRS-Id-r17 | PathlossReferenceRS-Id-r17 | OPTIONAL, -- Cond JointTCI1 |
| timingAdvanceRS-Id-r18 | TimingAdvanceRS-Id-r18 | |
| ul-powerControl-r17 | Uplink-powerControlId-r17 | OPTIONAL -- Cond JointTCI |

]]
}

Example 2 -UL TCI state configuration

| TCI-UL-State-r17 ::= | SEQUENCE { | |
|---|---|---|
| tci-UL-State-Id-r17 | TCI-UL-State-Id-r17, | |
| servingCellId-r17 | ServCellIndex | OPTIONAL, -- Need R |
| bwp-Id-r17 | BWP-Id | OPTIONAL,-- Cond CSI-RSorSRS- |

Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, -- Need R |
| ul-powerControl-r17 | Uplink-powerControlId-r17 | OPTIONAL, -- Need R |
| pathlossReferenceRS-Id-r17 | PathlossReferenceRS-Id-r17 | OPTIONAL, -- Cond Mandatory |

| | |
|---|---|
| timingAdvanceRS-Id-r18 | TimingAdvanceRS-Id-r18 |

...
}

As will be appreciated from the above discussion, the ‘timingAdvanceRS-Id’ field may indicate the identifier of the reference signal (e.g. a CSI-RS or an SS block) used for terminal device, UE, downlink reference timing when applying the timing advance, TA, value. It will also be appreciated that this field could have any other name, such ‘timingReferenceRS’.

In other examples, rather than being included in TCI state configurations, the first configuration information, which indicates a particular downlink reference signal that shall be used as the time reference for application of the timing advance value, may refer to multiple TCI states for which the particular downlink reference signal shall be used. For instance, the first configuration information may be included in a RRC configuration or re-configuration message or in a MAC CE.

In some examples, an indication of a particular downlink reference signal that shall be used by the terminal device as a time reference for application of a timing advance value when transmitting uplink signals may not be provided to the terminal. This may for instance occur because the provision of such an indication is not supported by the base station (or the network more widely). In such examples, terminal devices may recognise that configuration information received at the terminal device does not include such an indication and may respond to this by determining the time reference for application of the timing advance value when transmitting uplink signals in accordance with an instruction stored at the terminal device. In other examples, for instance, when the network is not configured to provide such indications, the terminal device may simply utilise the instructions stored at the terminal device, without any recognition or determination that the configuration information received at the terminal device does not include such an indication.

This instruction may indicate that the time reference shall be determined based on a time of receipt of a downlink reference signal associated with one of a set of TCI states that has a shorter (or the shortest) delay. That is, the terminal device may receive CSI reference signals associated with the set of different active TCI states and may identify which CSI reference signal is received with a shortest delay. The terminal device may then use the identified CSI reference signal as the time reference for application of the timing advance value when transmitting uplink signals. The TCI states of the set may be associated with the same TRP and so, even if the identity of the CSI RS arriving with the shortest delay changes, the actual delay should remain relatively constant. As such, similarly to the example described with reference to FIG. 2., the timing error may be kept relatively small. As will be appreciated, the set of TCI states may be any logical set of states, for instance, they may be the active TCI states for the terminal device, or may be associated with a particular control resource set, CORESET, or may be associated with a particular control resource set, CORESET pool index.

In other examples, the instruction may instead indicate that, when the terminal device has switched from use of an initial (or first) TCI state to use of a new (or second) TCI state, the time reference shall be determined based on a time of receipt of the downlink reference signal associated with the initial TCI state. As such, similarly to the example of FIG. 2, the CSI1 reference signal will continue to be used as the timing references even after the switch to CSI2. In some examples, the terminal may be configured such that this instruction is only followed if both TCI states (i.e. the initial and new TCI states) are associated with the same CORESET or TRP.

In yet other examples, the instruction may instead indicate that the time reference for uplink signals shall be determined based on a time of receipt of a reference signal that has been indicated to have a spatial relation with a physical uplink control channel, PUCCH, resource allocated to the terminal device. This reference signal may be referred to as the ‘spatial relation reference signal’ and may be explicitly indicated to the terminal device. In some cases, however, spatial relation reference signal may not be configured and 3GPP Rel16 specifies that the terminal device determines spatial relation reference signal as follows:
In case when CORESET(s) are configured on the control channel, the TCI state of the CORESET with the lowest ID shall be used as the spatial relation reference signal, or
In case when no CORESETs are configured on the control channel, the active TCI state with the lowest ID applicable to PDSCH in the active downlink bandwidth part (DL-BWP) of the control channel shall be used as the spatial relation reference signal.

Rel16 also introduced a default spatial relation for PUSCH scheduled by DCI format 0_0, where the terminal device determines the spatial relation reference signal as follows:
In the case when there are no PUCCH resources configured on the active UL BWP CC, the default spatial relation reference signal is the TCI state/QCL assumption of the CORESET with the lowest ID.
In the case when there are no PUCCH resources configured on the active UL BWP CC in FR2 and in RRC-connected mode, the default spatial relation reference signal is the TCI state/QCL assumption of the CORESET with the lowest ID.

In the above, it is described that these instructions stored at the terminal are applied when it is determined that an indication of the particular downlink reference signal that shall be used by the terminal device as a time reference for application of a timing advance value when transmitting uplink signals is not provided to the terminal. However, it will be appreciated that, in other implementations, the network may not be configured to provide such an indication. In such implementations, the terminal device may be configured to apply one of the instructions above when determining uplink timings. In this way, timing errors may be reduced without the signalling overhead associated with providing the indication of the particular downlink reference signal to the terminal device.

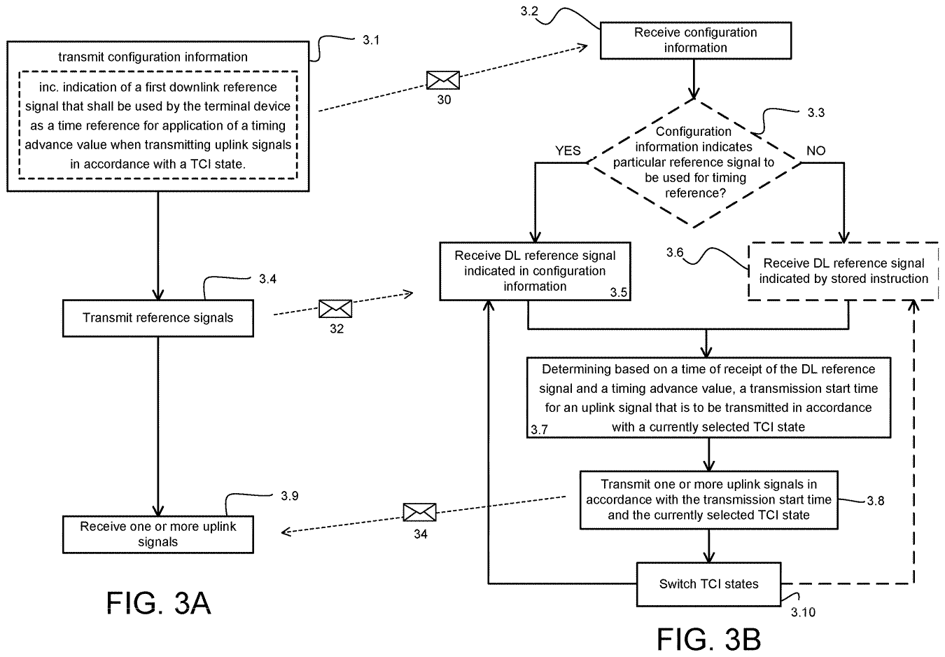

FIGS. 3A and 3B illustrate various operations that may be performed by the base station or TRP and terminal device in accordance with implementations described herein. Specifically, FIG. 3A illustrates operations that may be performed by the base station and FIG. 3B illustrates operations that may be performed by the terminal device.

In operation 3.1, the base station transmits configuration information 30 to the terminal device. As described with reference to some examples described herein, the configuration information 30 may include an indication of a particular downlink reference signal that shall be used by the terminal device as a time reference for application of a timing advance value when transmitting uplink signals in accordance with a particular TCI state. For instance, the indication may be included in TCI state configuration information. The terminal device may thus receive a respective TCI state configuration for each of multiple TCI states, with each TCI state configuration including the indication of the particular downlink reference signal.

In other examples, the indication may not be present in the TCI state configuration provided by the base station. In some examples described herein, the indication may not be sent at all. In other examples, the indication may be sent but may not be sent in the TCI state configuration. For instance, the configuration information 30 may associate plural TCI states with a particular reference signal that is to be used as the timing reference when transmitting uplink signals in accordance with those TCI states.

This may reduce the signalling overhead, but may reduce the flexibility available to the network. It will of course be appreciated that, even if an indication of the particular reference signal is not included in the TCI state configuration information, such TCI state configuration may still be sent to the terminal device.

In operation 3.2, the terminal device receives the configuration information 30.

In operation 3.3, the terminal device may determine whether the configuration information includes the indication of the particular reference signal to be used as the timing reference when transmitting uplink signals. If the indication is included in the configuration information, the terminal device may proceed to operation 3.5. If the indication is not included in the configuration information, the terminal device may proceed to operation 3.6.

It will of course be appreciated that, in some examples, operation 3.3 may be omitted. For instance, when the configuration information always includes such an indication, the terminal device may proceed from operation 3.2 to operation 3.5. Alternatively, for example when the network is not configured to provide such an indication, the terminal device may proceed from operation 3.2 to operation 3.6.

In operation 3.4, the base station transmits various reference signals 32.

In operation 3.5, the terminal device receives the reference signal 32 that the configuration information indicates shall be used be used as the timing reference when transmitting uplink signals. The terminal device then proceeds to operation 3.7.

Alternatively, in operation 3.6, the terminal device receives a reference signal 32 that instructions stored at the terminal device indicate shall be used be used as the timing reference when transmitting uplink signals. Various examples of such instructions are described above with reference to FIG. 2. The terminal device then proceeds to operation 3.7.

In operation 3.7, the terminal device determines, based on a timing advance value and on a time of receipt of the downlink signal received in the previous operation (i.e. either of operations 3.5 and 3.6), a transmission start time for an uplink signal that is to be transmitted in accordance with a currently selected TCI state. This determination is known to the person skilled in the art and may, for instance, be performed generally as described with reference to FIG. 2.

In operation 3.8, the terminal device transmits one or more uplink signals 34 in accordance with the determined transmission start time and the currently selected TCI state. These uplink signals 34 are received by the base station in operation 3.9.

In operation 3.10, the terminal device switches TCI states. For instance, the base station may instruct the terminal device, e.g. via a DCI, to switch from one active TCI state to another. After this, the terminal device returns to operation 3.5. Alternatively, if the configuration information did not include the indication of the particular reference signal to be used as the timing reference, the terminal device returns to operation 3.6.

As part of the switch of TCI states, the terminal device may determine the reference signal that shall be used as timing reference for determining uplink timing when transmitting uplink signals using the new TCI state. This may be determined based on the configuration information received in operation 3.2. state, which may be TCI state configurations. The reference signal is received in operation 3.5. As discussed above, the same reference signal may be indicated in both TCI state configurations (that is, the state configuration for the initial TCI state and the state configuration for the new TCI state), and thus timing errors resulting from TCI state switches may be reduced. Similarly, if the terminal device returned to operation 3.6, for instance because the network is not configured to indicate the reference signal to be used for determining uplink timing, the instructions stored at the terminal may, as discussed above, be configured such that a particular reference signal is utilised so that timing errors resulting from the TCI state switch are reduced.

Although not shown in FIG. 3, it will be appreciated that the base station, or another base station, may subsequently transmit new configuration information to the terminal device. This new configuration information may be as described above with respect to operations 3.1 and 3.2 but may be determined based on the new context of the terminal device. It will be appreciated that, in some examples, the new configuration information may omit the indication of the particular reference signal to be used as the timing reference when transmitting uplink signals, even when such an indication was included in the previously-received first configuration information. This may occur for instance, but not exclusively, when the new configuration information is transmitted by a different base station that does not support transmission of such an indication. When this new configuration information is transmitted, the terminal device may return to operation 3.2 in which the new configuration information is received, and the method may proceed from there.

It will of course be appreciated that the flow charts of FIGS. 3A and 3B are highly simplified and only indicate operations of the base station and terminal device that are relevant for understanding the approaches described herein. As such, it will be appreciated that various other operations involving the base station and terminal device are also performed. Such operations are known to the skilled person.

The approaches described herein have been described primarily with reference to switches between states that are associated with the same base station or TRP. However, it will be appreciated that, in some scenarios, the approaches may be used when switching between TCI states associated with different TRPs, for instance when the two TRPs are associated with a common cell.

Benefits of the approaches described herein have been discussed above and include reduced ISI. However, it will also be appreciated that the approaches described herein may promote terminal device support of multiple active TCI states. According to 3GPP TS 38.133, the terminal device is required to maintain accurate time tracking for all the TCI states on the active list, otherwise it may not be possible to indicate TCI state selection through DCI without waiting for the next SSB or CSI-RS. However, when various approaches described herein are used, the UE may not utilise the reference signals associated with each active TCI state to determine uplink timings. Instead, the terminal device may use just the SSB or an indicated one, or a subset, of the CSI-RSs associated with the activated TCI states to determine uplink timings. In section 7.1 of 3GPP TS38.133 (see below), it is assumed that the terminal device is only able to transmit in UL with accurate transmit timing if there is a SSB in the last 160 ms in FR2-1 (this accounts for the clock drift between SSB transmissions, and the accuracy in timing detection of the SSB signals). If the terminal device is able to maintain beam alignment by measuring CSI reference signals less often than 160 ms, then the UE can monitor the CSI RSs for all active TCI states much less often than the reference signals that are used for uplink timing (e.g. the wider SSB). As a result, by utilising certain approaches described herein, power consumption at the terminal device may be reduced. The overhead in performing measurements (like scheduling restrictions) may also be reduced by using the described approaches.

### Mapping to RAN4 Requirements

As described above, various approaches described herein may require new RRC signalling (for instance, a new field in TCI state configurations). However, it will also be appreciated that the 3GPP RAN4 (radio performance and protocol aspects) requirements may also needs to be updated in order to reflect the use of a particular reference signal for determination of uplink transmission timing. One example of how the RAN4 requirements may be updated is shown below with respects to clause 7.1 of 3GPP TS38.133 (in which terminal device, UE, transmit timing requirements are specified). The example updates to the technical specification (TS38.133) are underlined and in bold. It will of course be appreciated that not all of the updates illustrated below may be implemented, and that different wording may be used.

7 Timing
7.1 UE transmit timing

7.1.1 Introduction
The UE shall have capability to follow the frame timing change of the reference cell in connected state
or when transmitting PUSCH on CG resources for SDT in RRC_Inactive. The uplink frame
transmission takes place (N_{TA} + N_{TA offset}) × T_{c} before the reception of the first detected path (in time)
of the corresponding downlink frame from the reference cell. If the timing advance reference signal
is configured for the TCI state in which the UE is performing UL transmission, the configured
timing advance reference signal should be used as a time reference for UL transmission. For
serving cell(s) in pTAG, UE shall use the SpCell as the reference cell for deriving the UE transmit
timing for cells in the pTAG. For serving cell(s) in sTAG, UE shall use any of the activated SCells as
the reference cell for deriving the UE transmit timing for the cells in the sTAG. UE initial transmit
timing accuracy and gradual timing adjustment requirements are defined in the following requirements.
In the requirements of clause 7.1.2, the term reference cell on a carrier frequency subject to CCA is not
available at the UE refers to when at least one SSB is configured by gNB, but the first two successive
candidate SSB positions for the same SSB index within the discovery burst transmission window are
not available during at least one discovery burst transmission window, at the UE due to DL CCA
failures at gNB during the last 1280 ms; otherwise the reference cell on the carrier frequency subject to
CCA is considered as available at the UE.
7.1.2 Requirements
The UE initial transmission timing error shall be less than or equal to ±Tₑ where the timing error limit
value Tₑ is specified in Table 7.1.2-1. This requirement applies:

| | |
|---|---|
| - | when it is the first transmission in a DRX cycle or after joint DL/UL or UL TCI state switch |
| | when timing advance reference signal is configured for PUCCH, PUSCH and SRS, or it is |
| | the PRACH transmission, or it is the msgA transmission, or it is the first transmission sent on |
| | the PSCell for activating the deactivated SCG without RACH. |
| - | when it is the transmission for PUSCH on CG resources for SDT in RRC_Inactive. |

If the timing advance reference signal is not configured, when the UL SCS is 120 kHz or smaller,
the UE shall meet the Te requirement for an initial transmission provided that at least one SSB is
available at the UE during the last 160 ms. If the timing advance reference signal is configured, the
UE shall meet the Te requirement for an initial transmission provided that the timing advance
reference signal is available at the UE during the last 160 ms. When the UL SCS is 480 kHz the
UE shall meet the Te requirement for an initial transmission provided that at least one SSB is available
in the last 80 ms. When the UL SCS is 960 kHz the UE shall meet the Te requirement for an initial
transmission provided that at least one SSB is available in the last 40 ms. The reference point for the
UE initial transmit timing control requirement shall be the downlink timing of the reference cell minus
(N_{TA} + N_{TA offset}) × T_{c} . The downlink timing is defined as the time when the first path (in time) of the
corresponding downlink frame used by the UE to determine downlink timing is received from the
reference cell at the UE antenna. N_{TA} for PRACH is defined as 0.
(N_{TA} + N_{TA offset}) × T_{c} (in T_{c} units) for other channels is the difference between UE transmission
timing and the downlink timing immediately after when the last timing advance in clause 7.3 was
applied. N_{TA} for other channels is not changed until next timing advance is received. The value of
N_{TA offset} depends on the duplex mode of the cell in which the uplink transmission takes place and the
frequency range (FR). N_{TA offset} is defined in Table 7.1.2-2

### Example Configurations of Apparatuses

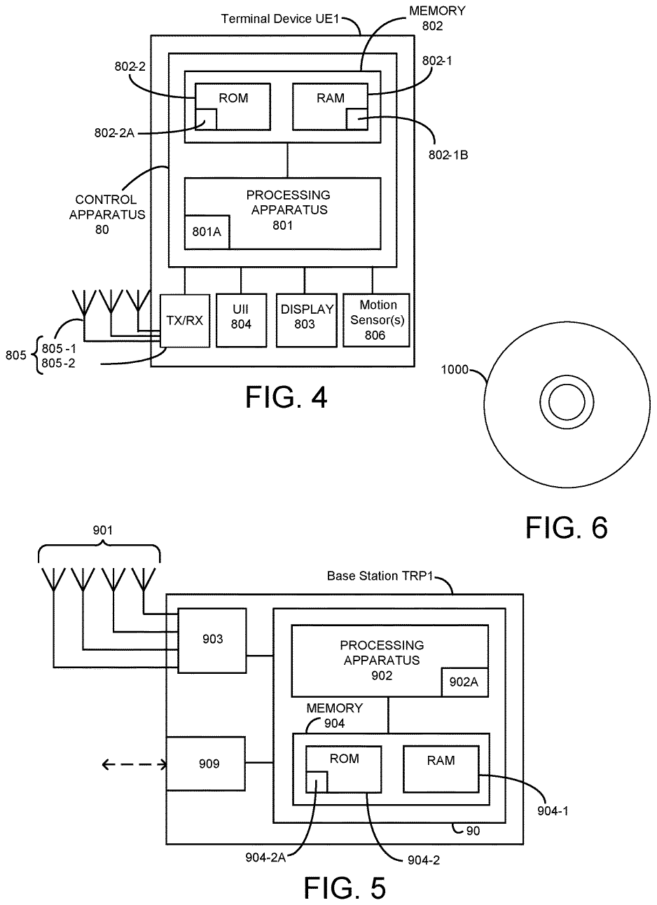

FIG. 4 is a schematic illustration of an example configuration of a terminal device UE1 which may be configured to perform various operations described with reference to FIGS. 1 to 3.

The terminal device UE1 may communicate, e.g. with a base station, via an appropriate radio interface arrangement 805. The interface arrangement 805 may be provided for example by means of a radio part 805-2 (e.g. a transceiver) and an associated antenna arrangement 805-1. The antenna arrangement 805-1 may be arranged internally or externally to the terminal device UE1. In order to be able to utilise beam forming, the antenna arrangement 805-1 includes multiple antennas. For instance, some UE's may include twelve antenna elements, e.g. four panels each having four cross-polarized antenna elements.

The terminal device UE1 comprises a controller/control (or processing) apparatus 80 which is operable to control the other components of the terminal device UE in addition to performing any suitable combinations of the operations described in connection with terminal device UE1 with reference to the preceding FIGS. The control apparatus 80 may comprise processing apparatus 801 and memory 802. Computer-readable code 802-2A may be stored on the memory 802, which when executed by the processing apparatus 801, causes the control apparatus 80 to perform any of the operations described herein in relation to the terminal device UE1.

Example configurations of the memory 802 and processing apparatus 801 will be discussed in more detail below

The terminal device UE1 may be, for example, a device that does not need human interaction, such as an entity that is involved in Machine Type Communications (MTC). Alternatively, the terminal device UE1 may be a device designed for tasks involving human interaction such as making and receiving phone calls between users and streaming multimedia or providing other digital content to a user. Non-limiting examples for the terminal device UE1 include a smart phone, a laptop, a smartwatch, a tablet computer, an e-reader, a vehicle-based terminal device, such as those mounted on cars, buses, uncrewed aerial vehicles (UAVs), aeroplanes, trains, or boats, or any type of terminal device that may be carried by a user, or worn on their person.

Where the terminal device UE is a device designed for human interaction, the user may control the operation of the terminal device UE1 by means of a suitable user input interface UII 804 such as keypad, voice commands, touch sensitive screen or pad, combinations thereof or the like. A display 803, a speaker and a microphone may also be provided. Furthermore, the terminal device UE1 may comprise appropriate connectors (either wired or wireless) to other devices and/or for connecting external accessories, for example hands-free equipment, thereto. The terminal device UE1 may additionally be associated with (e.g. comprises or is in short range wired or wireless communication with) one or a plurality of motion sensors 806 for sensing motion of the mobile device. The terminal device may additionally include other sensors such as a GNNS unit.

FIG. 5 is a schematic illustration of an example configuration of a base station or transmit receive point TRP1. The base station TRP1 is configured for communicating with the terminal device UE1 via a wireless interface. The base station TRP1 comprises a radio frequency antenna array 901 configured to receive and transmit radio frequency signals. Although the base station TRP1 is shown as having an array 901 of four antennas, this is illustrative only. The number of antennas may vary from two to many hundreds.

The base station TRP1 further comprises radio frequency interface circuitry 903 configured to interface between the antenna 901 and a control apparatus 90. The radio frequency interface circuitry 903 may also be known as a transceiver. The base station TRP1 also comprises one or more interfaces 909 via which it can communicate (e.g. via X2 messages) with other the base stations and other network entities such as those of the core network.

The TRP control apparatus 90 may be configured to process signals from the radio frequency interface circuitry 903, control the radio frequency interface circuitry 903 to generate suitable RF signals to communicate information to the UEs via the wireless communications link, and also to exchange information with other network elements via the interface 909.

The TRP control apparatus 90 may comprise processing apparatus 902 and memory 904. Computer-readable code 904-2A may be stored on the memory 904, which when executed by the processing apparatus 902, causes the control apparatus 90 to perform any of the operations assigned to the base station TRP1 described above.

As should of course be appreciated, the entities UE1, TRP1 shown in each of FIGS. 4 and 5 described above may comprise further elements which are not directly involved with processes and operations in respect which this application is focused.

Some further details of components and features of the above-described apparatus/entities/apparatuses UE1, TRP1 and alternatives for them will now be described.

The control apparatuses 80, 90 may comprise processing apparatus 801, 902 communicatively coupled with memory 802, 904. The memory 802, 904 has computer readable instructions 802-2A, 904-2A stored thereon, which when executed by the processing apparatus 801, 902 causes the control apparatus 80, 90 to cause performance of various ones of the operations described herein. The control apparatus 80, 90 may in some instances be referred to, in general terms, as “apparatus”.

The processing apparatus 801, 902 may be of any suitable composition and may include one or more processors 801A, 902A of any suitable type or suitable combination of types. For example, the processing apparatus 801, 902 may be a programmable processor that interprets computer program instructions 802-2A, 904-2A and processes data. The processing apparatus 801, 902 may include plural programmable processors. Alternatively, the processing apparatus 801, 902 may be, for example, programmable hardware with embedded firmware. The processing apparatus 801, 902 may be termed processing means. The processing apparatus 801, 902 may alternatively or additionally include one or more Application Specific Integrated Circuits (ASICs). In some instances, processing apparatus 801, 902 may be referred to as computing apparatus.

The processing apparatus 801, 902 is coupled to the memory (which may be referred to as one or more storage devices) 802, 904 and is operable to read/write data to/from the memory 802, 904. The memory 802, 904 may comprise a single memory unit or a plurality of memory units, upon which the computer readable instructions (or code) 802-2A, 904-2A is stored. For example, the memory 802, 904 may comprise both volatile memory 802-1 and non-volatile memory 802-2. For example, the computer readable instructions/program code 802-2A, 904-2A may be stored in the non-volatile memory 802-2, 904-2 and may be executed by the processing apparatus 801, 902 using the volatile memory 802-1, 904-1 for temporary storage of data or data and instructions. In some examples, a transmission buffer 802-1B of the TERMINAL DEVICE UE may be constituted by volatile memory 802-1 of the UE control apparatus 80. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions/program code 802-2A, 904-2A may be pre-programmed into the control apparatus 80, 90. Alternatively, the computer readable instructions 802-2A, 904-2A may arrive at the control apparatus 80, 90 via an electromagnetic carrier signal or may be copied from a physical entity 1000 such as a computer program product, a memory device or a record medium such as a CD-ROM or DVD an example of which is illustrated in FIG. 6. The computer readable instructions 802-2A, 904-2A may provide the logic and routines that enables the entities devices/apparatuses to perform the functionality described above. The combination of computer-readable instructions stored on memory (of any of the types described above) may be referred to as a computer program product.

Embodiments of the technology described herein may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing apparatus” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined. Similarly, it will also be appreciated that flow diagrams described herein are examples only and that various operations depicted therein may be omitted, reordered and or combined.

Although the methods and apparatuses have been described in connection with a New Radio (NR) network, it will be appreciated that they are not limited to such networks and are applicable to radio networks of various different types.

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while various examples are described above, these descriptions should not be viewed in a limiting sense. Rather, there are several variations and modifications which may be made without departing from the scope of the present invention as defined in the appended claims.

1-26. (canceled)

27. An apparatus comprising at least one processor and at least one memory storing instructions that, when executed by the at least one processor, cause the apparatus at least to perform:
receiving first configuration information which includes an indication that a first downlink reference signal shall be used by the apparatus as a time reference for application of a timing advance value when transmitting uplink signals in accordance with a first transmission configuration indicator (TCI) state;
receiving the first downlink reference signal;
determining, based on a time of receipt of the first downlink reference signal and the timing advance value, a transmission start time for an uplink signal that is to be transmitted in accordance with the first TCI state; and
transmitting the uplink signal in accordance with the transmission start time and the first TCI state.

28. The apparatus of claim 27, wherein TCI state configuration information comprises the first configuration information.

29. The apparatus of claim 28, wherein the TCI state configuration information includes a first TCI state configuration corresponding to the first TCI state and a second TCI state configuration corresponding to a second TCI state,
wherein the first TCI state configuration includes an indication that the first downlink reference signal shall be used by the apparatus as the time reference for application of the timing advance value when transmitting uplink signals in accordance with the first TCI state, and
wherein the second TCI state configuration includes an indication that the first downlink reference signal shall be used by the apparatus as the time reference for application of the timing advance value when transmitting uplink signals in accordance with the second TCI state.

30. The apparatus of claim 29, wherein the apparatus is further caused to at least perform:
switching from transmitting uplink signals in accordance with the first TCI state to transmitting uplink signals in accordance with the second TCI state while keeping the first downlink reference signal as the time reference for application of the timing advance value when transmitting uplink signals in accordance the second TCI state.

31. The apparatus of claim 29, wherein the first downlink reference signal is transmitted using a third beam that is wider than a first beam associated with the first TCI state and a second beam associated with the second TCI state.

32. The apparatus of claim 31, wherein the third beam spatially overlaps the first beam and the second beam.

33. The apparatus of claim 27, wherein the first configuration information indicates a plurality of TCI states for which the first downlink reference signal shall be used as the time reference for application of the timing advance value when transmitting uplink signals in accordance with any TCI state of the plurality of TCI states,
and wherein the plurality of TCI states includes the first TCI state and a second TCI state.

34. The apparatus of claim 27, wherein the first downlink reference signal is a synchronisation signal block (SSB), or a channel state information reference signal (CSI-RS).

35. The apparatus of claim 27, wherein the first configuration information is included in a Radio Resource Control (RRC) configuration or re-configuration message, or in a Medium Access Control (MAC) control element.

36. The apparatus of claim 27, wherein the apparatus is further caused to at least perform:
receiving new configuration information for configuring transmission of uplink signals by the apparatus;
determining that the new configuration information received at the apparatus does not include an indication that a particular downlink reference signal shall be used by the apparatus as a time reference for application of a timing advance value when transmitting uplink signals;
means for, responsive to determining that the new configuration information received at the apparatus does not include an indication that a particular downlink reference signal shall be used by the apparatus as a time reference for application of a timing advance value when transmitting uplink signals, determining the time reference in accordance with an instruction stored at the terminal device.

37. The apparatus of claim 36, wherein the instruction indicates that the time reference shall be determined based on a time of receipt of a downlink reference signal associated with one of a set of activated TCI states that is detected with a shortest path delay.

38. The apparatus of claim 37, wherein the activated TCI states of the set of activated TCI states are associated with a single transmit-receive point (TRP), or are associated with a particular control resource set (CORESET), or are associated with a particular CORESET pool index.

39. The apparatus of claim 36, wherein the instruction indicates that, when the apparatus has switched from use of an initial TCI state to use of a new TCI state, the time reference shall be determined based on a time of receipt of a downlink reference signal associated with the initial TCI state.

40. The apparatus of claim 36, wherein the instruction indicates that the time reference shall be determined based on a time of receipt of a reference signal that has been indicated to have a spatial relation with a physical uplink control channel (PUCCH) resource allocated to the terminal device.

41. An apparatus comprising at least one processor and at least one memory storing instructions that, when executed by the at least one processor, cause the apparatus at least to perform:
transmitting, to a terminal device, first configuration information which includes an indication that a first downlink reference signal shall be used by the terminal device as a time reference for application of a timing advance value when transmitting uplink signals in accordance with a first transmission configuration indicator (TCI) state.

42. The apparatus of claim 41, wherein TCI state configuration comprises the first configuration information.

43. The apparatus of claim 42, wherein the TCI state configuration information includes a first TCI state configuration corresponding to the first TCI state and a second TCI state configuration corresponding to a second TCI state, and wherein the first TCI state configuration includes an indication that the first downlink reference signal shall be used by the terminal device as the time reference for application of the timing advance value when transmitting uplink signals in accordance with the first TCI state, and wherein the second TCI state configuration includes an indication that the first downlink reference signal shall be used by the terminal device as the time reference for application of the timing advance value when transmitting uplink signals in accordance with the second TCI state.

44. The apparatus of claim 43, wherein the first downlink reference signal is transmitted using a third beam that is wider than a first beam associated with the first TCI state and a second beam associated with the second TCI state.

45. The apparatus of claim 41, wherein the first configuration information indicates a plurality of TCI states for which the first downlink reference signal shall be used as the time reference for application of the timing advance value when transmitting uplink signals in accordance with any TCI state of the plurality of TCI states, and wherein the plurality of TCI states includes the first TCI state and a second TCI state.

46. A method comprising, by a terminal device:
receiving first configuration information which includes an indication that a first downlink reference signal shall be used by the terminal device as a time reference for application of a timing advance value when transmitting uplink signals in accordance with a first transmission configuration indicator (TCI) state;
receiving the first downlink reference signal;
determining, based on a time of receipt of the first downlink reference signal and the timing advance value, a transmission start time for an uplink signal that is to be transmitted in accordance with the first TCI state; and
transmitting one or more uplink signals in accordance with the transmission start time and the first TCI state.
